(19) United States
(12) Patent Application Publication
(10) Pub. No.: US 2017/0008462 A1
(43) Pub. Date: Jan. 12, 2017

(54) SILENCER FOR AUTOMOBILE

(71) Applicant: HAYASHI TELEMPU Co., Ltd., Nagoya-shi (JP)

(72) Inventors: Takahiko TANIGUCHI, Aichi (JP); Wataru HASHIMOTO, Aichi (JP); Itaru ASHIMINE, Aichi (JP)

(73) Assignee: HAYASHI TELEMPU Co., Ltd.

(21) Appl. No.: 15/271,238

(22) Filed: Sep. 21, 2016

Related U.S. Application Data
(63) Continuation of application No. PCT/JP2015/055224, filed on Feb. 24, 2015.

(30) Foreign Application Priority Data
Mar. 25, 2014 (JP) 2014-061208

(51) Int. Cl. B60R 13/08; G10K 11/168

(52) U.S. Cl. CPC B60R 13/083; B60R 13/0861; B60R 13/0838; G10K 11/168

(57) ABSTRACT

The present invention discloses a silencer for automobile. The silencer is formed by press molding. The silencer has a first molding surface and a second molding surface which are opposite to each other in a thickness direction. The silencer includes a buffer material in which fibers are oriented in the thickness direction and a fiber assembly in which fibers are oriented in a different direction from the direction of the fibers of the buffer material. The buffer material in which fibers are oriented in the thickness direction is inserted into the fiber assembly in which fibers are oriented in the different direction so that a lamination portion is formed by partly laminating the buffer material on the fiber assembly.

### CROSS-REFERENCES TO RELATED APPLICATIONS

This Application claims the benefit of priority and is a Continuation application of the prior International Patent Application No. PCT/JP2015/055224, with an international filing date of Feb. 24, 2015, which designated the United States, and is related to the Japanese Patent Application No. 2014-061208, filed Mar. 25, 2014, the entire disclosures of all applications are expressly incorporated by reference in their entirety herein.

### BACKGROUND OF THE INVENTION

1. Field of the Invention

The present invention relates to a press molded silencer for automobile.

2. Description of Related Art

For example, a floor silencer interposed between a floor panel and a floor carpet is known as the silencer installed on the automobile. The floor silencer has a function of noise insulation, a function of preventing unevenness of the floor panel from appearing on the surface of the carpet, and a function of giving comfortable feeling to a passenger who steps on the floor carpet. A fibrous silencer is used as the silencer for realizing these functions.

In Japanese Unexamined Patent Application Publication No. H07-223478, a nonwoven fabric formed by mixing 70% of 6 denier polyester fiber having high melting point and 30% of 2 denier polyester fiber having low melting point is used for a buffer material layer of the floor carpet for the automobile.

In a floor carpet for automobile disclosed in Japanese Unexamined Patent Application Publication No. H11-139194, a buffer material is provided on a floor surface of attaching the floor carpet and provided on an upper surface and a side surface of a center tunnel. The buffer material is formed by at least two kinds of polyester nonwoven fabrics having different composition and/or weight per unit area (surface density).

When the polyester nonwoven fabric is used for the buffer material, the fibers of the buffer material are oriented along a back surface of the floor carpet.

### BRIEF SUMMARY OF THE INVENTION

If density of the silencer is low when the fibers of the silencer are oriented along the back surface of the floor carpet, “settling” may occur when a passenger steps on the floor carpet with his/her foot. The “settling” is a situation that the silencer is compressed in a thickness direction and not returned to an original thickness. When the fibers of the silencer are oriented in the above described direction, the density of the silencer should be higher to increase compressive strength in the thickness direction of the silencer.

The above described problem also occurs in various silencers for automobile without limited to the silencer for the floor carpet.

The present invention discloses a new silencer for automobile, the silencer partly having high compressive strength in the thickness direction.

One aspect of the present invention provides a silencer for automobile, the silencer being formed by press molding, the silencer having a first molding surface and a second molding surface which are opposite to each other in a thickness direction, the silencer comprising:
a buffer material in which fibers are oriented in the thickness direction;
a fiber assembly in which fibers are oriented in a different direction from the direction of the fibers of the buffer material, wherein
the buffer material in which fibers are oriented in the thickness direction is inserted into the fiber assembly in which fibers are oriented in the different direction so that a lamination portion is formed by partly laminating the buffer material on the fiber assembly.

### BRIEF DESCRIPTION OF THE DRAWINGS

FIG. 1 is a perspective view showing an example of an outer appearance of a silencer and a skin material viewed from a vehicle compartment C1 side.

FIG. 2 is a drawing showing an example of a vertical end surface of the silencer together with a vehicle body panel and the skin material cut at the position corresponding to A1-A1 in FIG. 1.

FIG. 3 is a side view showing an example of a main portion of a buffer material 40E in which folded-back portions 47 are kept remained.

FIG. 4A is a perspective view showing an example of a main portion of the buffer material 40E in which the folded-back portions 47 are kept remained. FIG. 4B is a perspective view showing a main portion of a buffer material 40F from which the folded-back portions 47 are cut off.

FIGS. 5A and 5B are drawings showing an example of a vertical end surface of another silencer 1 cut at the position corresponding to A1-A1 in FIG. 1.

FIG. 6 is a block diagram schematically showing an example of a manufacturing method of the silencer.

FIG. 7 is a vertical end surface view for explaining an example of a manufacturing method of the silencer.

FIG. 8 is a drawing showing an example of a vertical end surface of another silencer together with the vehicle body panel and the skin material cut at the position corresponding to A1-A1 in FIG. 1.

FIGS. 9A and 9B are drawings showing an example of a vertical end surface of another silencer together with the vehicle body panel and the skin material cut at the position corresponding to A1-A1 in FIG. 1.

FIG. 10 is a drawing showing an example of a vertical end surface of another silencer together with the vehicle body panel and the skin material cut at the position corresponding to A1-A1 in FIG. 1.

FIG. 11 is a drawing showing an example of a vertical end surface of another silencer together with the vehicle body panel and the skin material cut at the position corresponding to A1-A1 in FIG. 1.

### DETAILED DESCRIPTION OF THE INVENTION

Hereafter, embodiments of the present invention will be explained. Of course, the below-described embodiments merely exemplify the present invention. All features disclosed in the embodiments are not necessarily essential for solving the present invention.

(1) Outline of Technology Included in the Present Invention

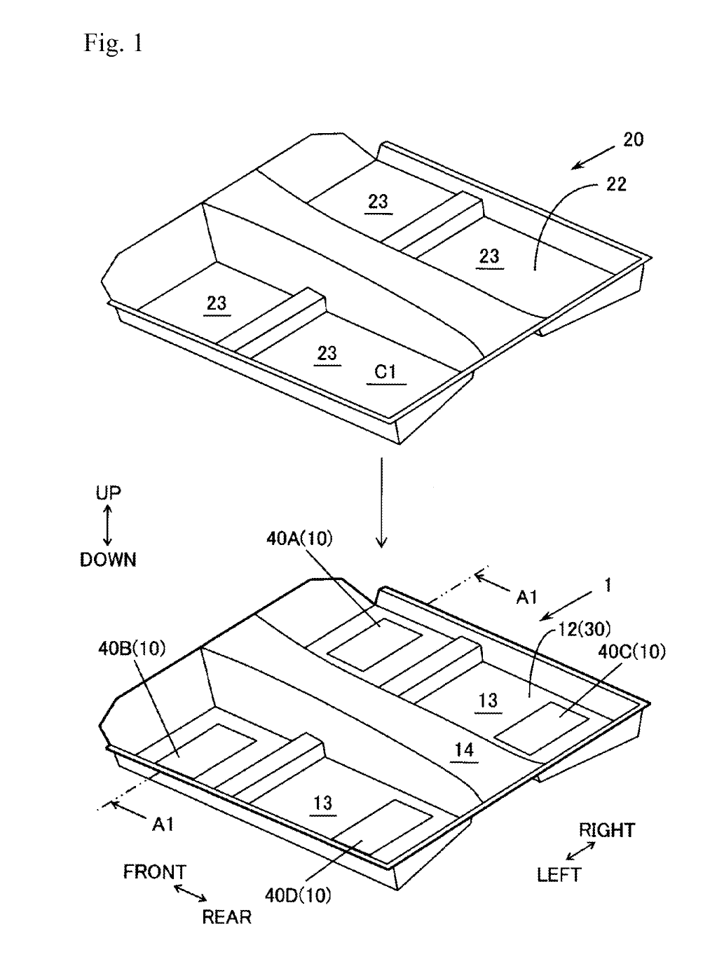

First, with reference to schematic examples shown in FIGS. 1 to 9, an outline of the technology included in the present invention will be explained.

A silencer 1 for automobile according to the present technology is formed by press molding. The silencer 1 has a first molding surface 11 and a second molding surface 12 which are opposite to each other in a thickness direction. In the silencer 1, a buffer material 40 in which fibers 44 are oriented in a thickness direction D3 is inserted into a fiber assembly 30 in which the fibers are oriented in a different direction from the direction of the fibers of the buffer material 40 so that a lamination portion 10 is formed by partly laminating the buffer material 40 on the fiber assembly 30.

In the buffer material 40, since the fibers 44 are oriented in the thickness direction D3, compressive strength in the thickness direction D3 is high. Thus, the buffer material 40 is hardly deformed in the thickness direction D3 even when press molding is performed. The buffer material 40 is partly laminated on the fiber assembly 30 in which the fibers are oriented in the different direction from the direction of the fibers of the buffer material 40. Thus, the present technology can provide a new silencer for automobile partly having high compressive strength in the thickness direction.

The silencer of the present technology can be installed, for example, on a floor portion of the vehicle compartment, a side wall portion of the vehicle compartment, a ceiling portion of the vehicle compartment, a deck floor portion, a dashboard portion, an engine hood portion and a fender portion. The silencer can be installed on an interior part and an exterior part.

If the fibers of the buffer material are oriented in the thickness direction, it means that an orientation direction of the fibers matches relatively well with a direction orthogonal to an outer surface of the front side and an outer surface of the back side of the buffer material. In addition, the folded-back portion for orienting the fibers in the thickness direction can be formed. Since the fibers constituting the buffer material can have a curved shape, the fibers of the buffer material being oriented in the thickness direction does not mean that straight fibers are arranged parallel to each other in the thickness direction of the buffer material.

From the above, the buffer material in which fibers are oriented in the thickness direction can be the buffer material of a wavelike shape in which webs are repeatedly folded back in the thickness direction, the buffer material obtained by dividing the buffer material having the wavelike shape into two parts at the middle in the thickness direction, the buffer material in which folded-back portions of the buffer material having the wavelike shape are cut out, and the buffer material in which webs are repeatedly laminated, for example.

The fibers constituting the buffer material can be a single kind of fiber or a combination of two or more kinds of fibers, such as a combination of a main fiber and an adhesive fiber. The fibers constituting the fiber assembly can also be a single kind of fiber or a combination of two or more kinds of fibers, such as a combination of a main fiber and an adhesive fiber.

Even if the thickness direction of the silencer does not completely matches with the thickness direction of the buffer material, such a configuration is also included in the present technology.

The lamination portion includes the portion where the buffer material and the fiber assembly are in contact with each other in the thickness direction, and also includes the portion where another layer such as a resin layer is formed between the buffer material and the fiber assembly.

In the silencer for automobile, a member such as a formed molding can be attached afterward to at least one of the first molding surface and the second molding surface, and such a configuration is also included in the silencer of the present technology.

In the lamination portion 10, the density of the buffer material 40 can be equal to or lower than the density of the fiber assembly 30. This embodiment can provide a light-weight silencer having comfortable feeling. In the lamination portion 10, when the density of the buffer material 40 is lower than the density of the fiber assembly 30, the weight of the silencer for automobile can be lighter and the feeling can be more comfortable.

A concave portion 31 can be formed on an outer surface of the fiber assembly 30, and the buffer material 40 can be inserted into the concave portion 31. This embodiment can provide the silencer having more combatable feeling.

The fibers of the buffer material 40 may include a main fiber 45 and a binder (adhesive fiber 46). The buffer material 40 can be adhered to on a bottom portion 31b of the concave portion 31 of the fiber assembly 30 and a side portion 31a of the concave portion 31 of the fiber assembly 30. In this embodiment, since the binder (46) is included in the fibers of the buffer material 40, the shape of the press-molded buffer material 40 can be maintained. Furthermore, the buffer material 40 adheres to not only the bottom portion 31b of the concave portion 31 of the fiber assembly 30 but also the side portion 31a of the concave portion 31. Accordingly, in the silencer of this embodiment, the buffer material in which the fibers are oriented in the thickness direction can have good adhesiveness to the fiber assembly.

A main fiber 35 and a binder (adhesive fiber 36) can be included in fibers 34 of the fiber assembly 30. The bottom portion 31b of the concave portion 31 of the fiber assembly 30 and the side portion 31a of the concave portion 31 of the fiber assembly 30 can be adhered to on the buffer material 40. In this embodiment, since the binder (36) is included in the fibers 34 of the fiber assembly 30, the shape of the press-molded fiber assembly 30 can be maintained. Furthermore, the buffer material 40 adheres to not only the bottom portion 31b of the concave portion 31 of the fiber assembly 30 but also the side portion 31a of the concave portion 31. Accordingly, in the silencer 1 of this embodiment, the buffer material in which the fibers are oriented in the thickness direction can have good adhesiveness to the fiber assembly.

When the first molding surface 11 is located at the vehicle body panel 80 side and the second molding surface 12 is located at the skin material (carpet 20) side, the outer surface (40a) of the buffer material 40 can be included in the second molding surface 12. Since the buffer material 40 in which the fibers 44 are oriented in the thickness direction D3 is located at the skin material (20) side of the silencer 1, the feeling of the buffer material 40 can be obtained easily. Accordingly, this embodiment can provide the silencer having more combatable feeling.

The skin material includes a carpet, woven fabric, nonwoven fabric, resin, elastomer and rubber, for example.

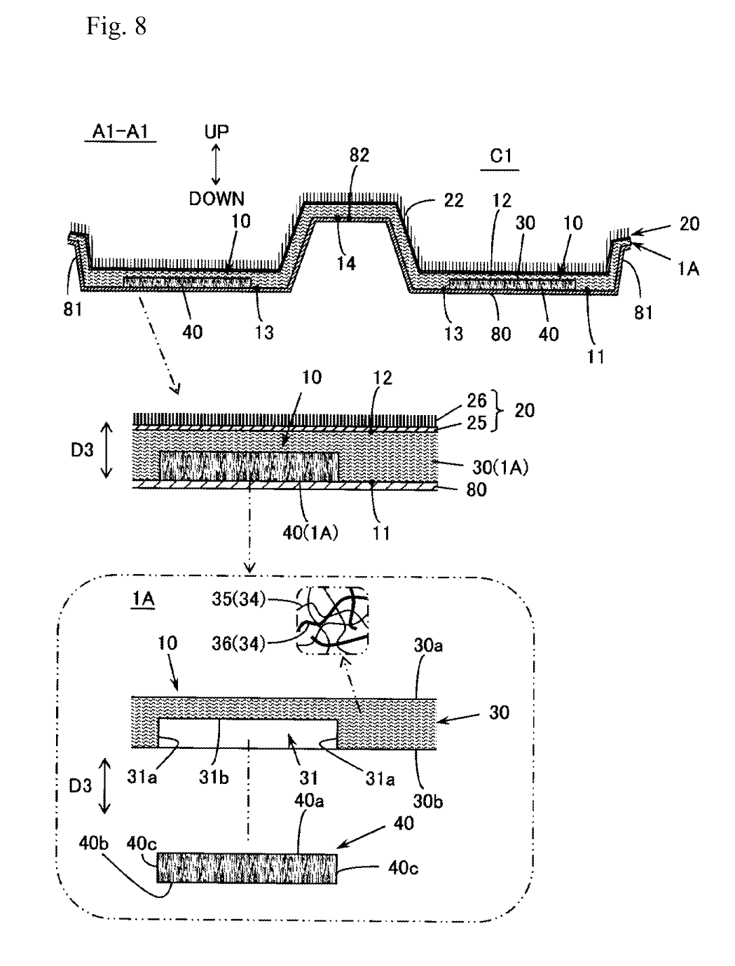

An outer surface (40b) of the buffer material 40 can be included in the first molding surface 11 (as shown in FIG. 8, for example). Since the buffer material 40 in which the fibers 44 are oriented in the thickness direction D3 is located at the vehicle body panel 80 side, the load applied from the skin material (20) side to the vehicle body panel 80 side is supported by the fibers 44 oriented in the thickness direction D3 of the buffer material 40 via the fiber assembly 30. Accordingly, this embodiment can provide the silencer having higher compressive strength in the thickness direction.

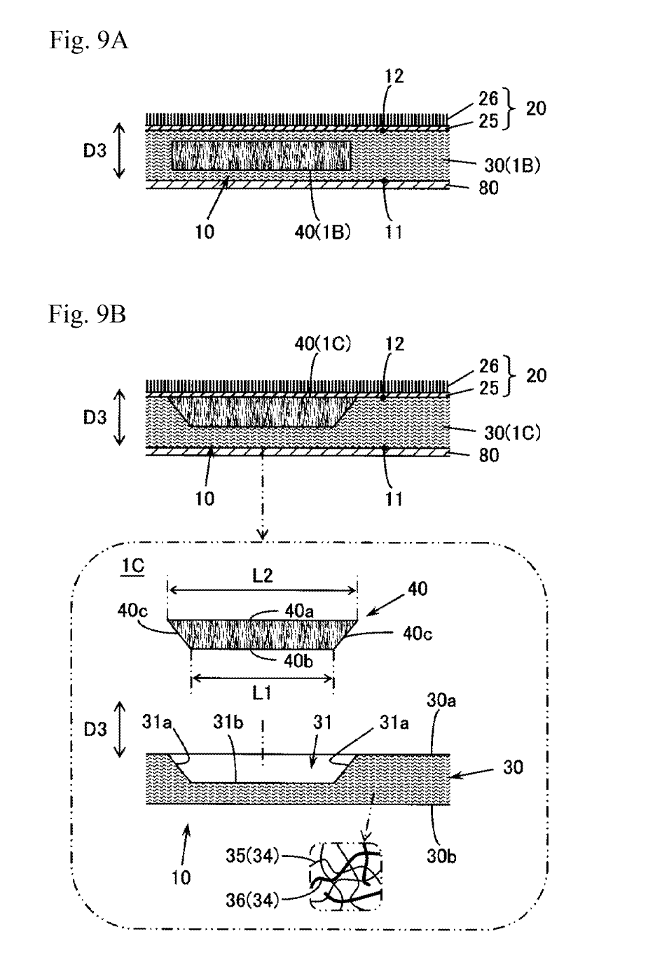

The buffer material 40 can be formed in an approximately trapezoidal cross section when cut along the thickness direction D3 so that a length L1 of a side at the first molding surface 11 side is different from a length L2 of a side at the second molding surface 12 side (as shown in FIG. 9B, for example). When the buffer material 40 is formed in an approximately trapezoidal cross section, adhesive strength between the buffer material 40 and the fiber assembly 30 becomes higher at a circumferential portion 40c compared to the buffer material 40 having a rectangular cross section. Accordingly, this embodiment can improve adhesiveness of the buffer material adhered to on the fiber assembly.

The fibers 34 of the fiber assembly 30 can be oriented randomly. In this embodiment, the buffer material 40 is hardly deformed in the thickness direction when press molding is performed. Thus, this embodiment can provide the silencer having higher compressive strength.

When the first molding surface 11 is located at the floor panel (80) side and the second molding surface 12 is located at the skin material (20) side, the lamination portion 10 can be located at the floor panel (80) of the skin material (20) at a portion (footrest portion 23) where a foot of a passenger is placed. Since the buffer material 40 in which the fibers 44 are oriented in the thickness direction D3 is located at the floor panel (80) side of the skin material (20) at the portion (footrest portion 23) where the foot of the passenger is placed, this embodiment can provide the silencer for the floor of automobile having good performance when stepped on by the foot.

(2) Concrete Example of the Silencer

FIGS. 1 to 9 show examples of applying the silencer of the present technology to the silencer for the floor of the automobile. In the figures, FRONT, REAR, LEFT, RIGHT, UP and DOWN respectively represent the front, rear, right, left, up and down side of the automobile. Positional relation of the left and right is based on a direction of viewing the front from the rear of the automobile. A reference numeral D1 indicates a lamination direction of a web M1. A reference numeral D2 indicates a width direction of the web M1. A reference numeral D3 indicates a thickness direction of the buffer material 40. A reference numeral D11 indicates an extruding direction of the buffer material 40 extruded by the buffer material manufacturing apparatus. A reference numeral D12 indicates an opposite direction of the extruding direction D11. The directions D1, D2 and D3 are perpendicular to each other. However, the present invention also includes the case where the directions D1, D2 and D3 are not perpendicular to each other as long as the directions D1, D2 and D3 are different directions. To make the explanation easier, magnification ratios of the directions D1, D2 and D3 may be different, and each of the figures may not fit together.

The silencer of the present technology is suitably used for a floor silencer laid on the vehicle body panel of the automobile. The floor silencer is used for securing performance such as cushioning performance and soundproof performance of the floor of the automobile, for example. Since there is unevenness on the vehicle body panel, the floor silencer is formed in the shape fitting to the unevenness of the vehicle body panel and laid on the vehicle body panel.

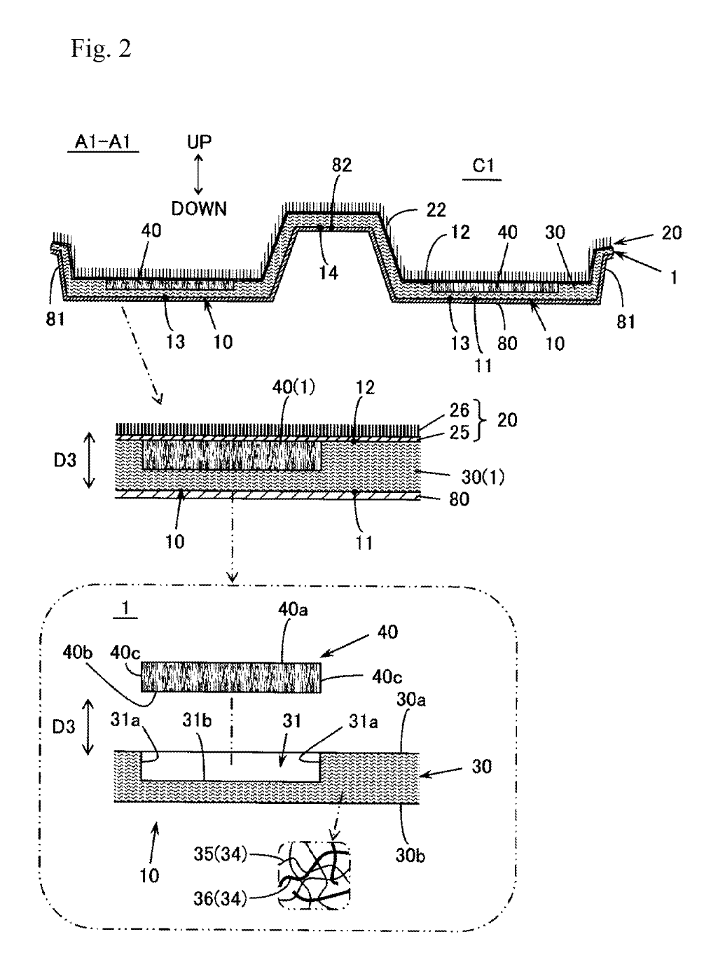

The silencer 1 for automobile shown in FIG. 1 is a functional material mounted on a floor panel (a kind of the vehicle body panel) having an approximately flat shape to form the floor surface of the vehicle, a toe board panel (a kind of the vehicle body panel) rising upward from the floor panel surface at the front part in the occupant compartment, and other vehicle body panels. A tunnel portion (raised portion) 82 is formed at the center in a vehicle width direction of the floor panel and the toe board panel so as to be projected upward and extended to the front and rear. As shown in FIG. 2, both edge portions 81, 81 of the vehicle body panel 80 in the vehicle width direction are projected outward in the vehicle width direction. The silencer 1 for the vehicle compartment is laid on the vehicle compartment C1 side of the vehicle body panel 80. The silencer 1 is formed into a three dimensional shape fitting to a vertical wall of the protrusion such as a console and a rocker panel. The silencer 1 shown in FIGS. 1 and 2 has a tunnel portion 14 projected upward and extended to the front and rear fitting to the tunnel portion 82 of the vehicle body panel, and approximately flat portions 13, 13 fitting to an approximately flat portion of the vehicle body panel 80 at the outer side of the tunnel portion 14 in the vehicle width direction. A floor carpet (skin material) 20 is laid on the vehicle compartment C1 side of the silencer 1. The floor carpet 20 is formed into a three dimensional shape fitting to a vertical wall of the protrusion of the silencer 1 to decorate inside the occupant compartment.

A concavo-convex shape 22 of the vehicle compartment C1 side is formed on the floor carpet 20 shown in FIGS. 1 and 2 by press molding, and the floor carpet 20 is arranged to face the vehicle compartment C1. The carpet 20 is a tufted carpet having back stitches of piles 26 in a base layer 25, for example. A large number of piles 26 are raised on the vehicle compartment C1 side of the base layer 25. For the foundation cloth constituting the base layer 5, nonwoven fabrics such as a spunbond nonwoven fabric and knitted materials of various kinds of fibers can be used, for example. A backing can be provided on the reverse surface (surface of the silencer 1 side) of the foundation cloth. For the backing, resin materials (inclusive of elastomers) and fiber materials can be used, for example. Of course, for the carpet 20, a needle punched carpet, in which a nonwoven fabric is needled to intertwine fibers and fluff is formed on the surface, can be also used, for example.

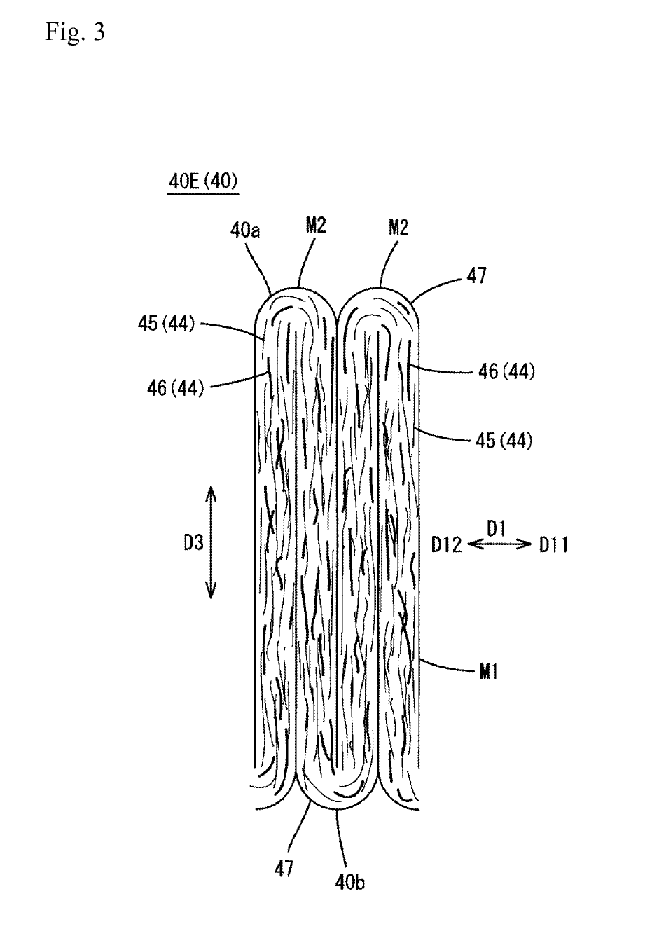

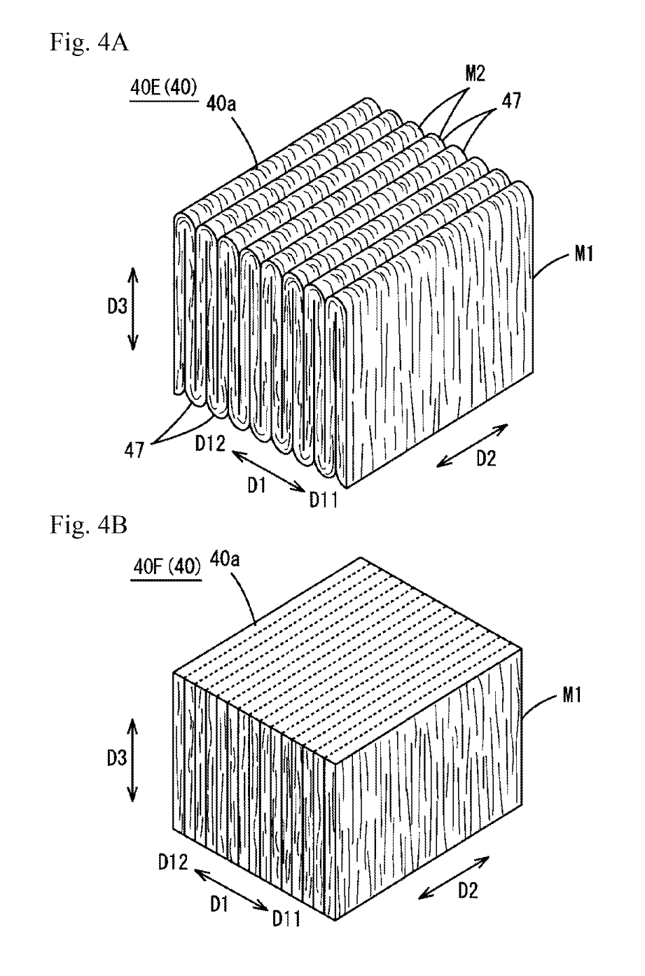

In the silencer 1, a concavo-convex shape is formed by press molding on the first and second molding surfaces 11, 12 which are opposite to each other in the thickness direction D3. The silencer 1 is installed between the vehicle body panel 80 and the floor carpet 20. Here, the first molding surface 11 is located at the floor panel (vehicle body panel 80) side, and the second molding surface 12 is located at the carpet 20 side. As shown in FIGS. 3 and 4, the buffer material 40 in which the fibers 44 are oriented in the thickness direction D3 is inserted into the fiber assembly 30 in which the fibers are oriented in a direction different from the direction of the fibers 44 of the buffer material 40 to form the silencer 1 by press molding. Consequently, the silencer 1 has the lamination portion 10 in which the buffer material 40 is partly laminated on the fiber assembly 30. In the silencer 1 shown in FIG. 1, the lamination portion 10 is located at the floor panel side of the footrest portion 23 of the carpet 20. The footrest portion 23 is a portion where a foot of a passenger is placed. FIG. 1 shows that a buffer material 40A is inserted into the fiber assembly 30 located at the foot of the driver seat, a buffer material 40B is inserted into the fiber assembly 30 located at the foot of the front passenger seat, a buffer material 40C is inserted into the fiber assembly 30 located at the foot of the rear seat of the driver seat side, and a buffer material 40D is inserted into the fiber assembly 30 located at the foot of the rear seat of the front passenger seat side. The buffer materials 40A to 40D and the buffer materials 40E, 40F shown in FIGS. 4A and 4B are collectively called “buffer material 40.” The number of the buffer materials to be inserted is not particularly limited. The silencer is included in the present technology even when the buffer material is not inserted into the fiber assembly at the foot of one or some seats, and even when a plurality of buffer materials is inserted into the fiber assembly at the foot of one or some seats.

On an outer surface 30a of front side (carpet 20 side) of the fiber assembly 30 shown in FIG. 2, a concave portion 31 recessed toward the vehicle body panel 80 side is formed. In a lower part of FIG. 2, the fiber assembly 30 and the buffer material 40 are shown in a disassembled state for convenience of the explanation. In the enlarged views of before and after disassembled, the horizontal to vertical ratio is different from that of the figure before enlargement to make the explanation easier. As shown in the enlarged view before disassembled in FIG. 2, the buffer material 40 is inserted into the concave portion 31, the bottom portion 31b of the concave portion 31 is adhered to on an outer surface 40b of the back side (vehicle body panel 80 side) of the buffer material 40, and the side portion 31a of the concave portion 31 is adhered to on the circumferential portion 40c of the buffer material 40.

Here, the circumferential portion 40c of the buffer material is a portion surrounding the outer surfaces 40a, 40b at a position between the outer surfaces 40a, 40b. The bottom portion 31b of the concave portion 31 shown in FIG. 2 means a surface (portion) approximately perpendicular (crossing) to the thickness direction D3 in the concave portion 31. The side portion 31a of the concave portion 31 shown in FIG. 2 means a surface (portion) surrounding the bottom portion 31b in the concave portion 31. An outer surface 30a of the front side of the fiber assembly 30 located around the concave portion 31 and an outer surface 40a of the front side of the buffer material 40 correspond to the second molding surface 12. On the other hand, on an outer surface 30b of the back side of the fiber assembly 30, the concave portion into which the buffer material is inserted is not formed. Accordingly, the outer surface 30b of the back side corresponds to the first molding surface 11. The outer surface of the buffer material 40 is not included in the first molding surface 11.

The buffer material 40 shown in FIG. 2 has approximately rectangular shape in a cross section along the thickness direction D3 when macroscopically seen. The buffer material 40 is formed in a three-dimensional shape having a size of substantially filling the concave portion 31 of the fiber assembly. Accordingly, the buffer material 40 can be formed at a lower cost. Since the thickness of the buffer material 40 is substantially matched to the depth of the concave portion 31, the buffer material 40 inserted into the concave portion 31 is not protruded (convex shape) from the outer surface 30a of the front side located around the buffer material 40. Thus, the outer surface 40a of the front side of the buffer material 40 and the outer surface 30a of the front side of the fiber assembly 30 become approximately flat. Accordingly, the floor carpet 20 near the foot is not projected, and the feeling when stepped on the floor carpet 20 is good. When the difference in level between the outer surface 40a of the front side of the buffer material and the outer surface 30a of the front side of the fiber assembly is 0.3 times or less of the thickness of the buffer material 40 (more preferably 0.2 times or less, furthermore more preferably 0.1 times or less), the outer surface 40a of the front side of the buffer material and the outer surface 30a of the front side of the fiber assembly are approximately flat.

The above explanations are made for the silencer 1 as a final product. The above explanations do not limit the timing of forming the concave portion 31 of the fiber assembly in the manufacturing process. Accordingly, the concave portion 31 can be preliminarily formed on the fiber assembly 30 before finally forming the silencer 1. Otherwise, the concave portion 31 can be formed when finally forming the silencer 1 by making the buffer material 40 sink into the fiber assembly 30. As described later, the buffer material 40 has high compressive strength in the thickness direction D3. Hence, it is preferred that the concave portion 31 is formed when finally forming the silencer 1 by making the buffer material 40 sink into the fiber assembly 30.

The fibers 34 constituting the fiber assembly 30 shown in FIG. 2 are oriented randomly. Because of this, the buffer material 40 in which the fibers 44 are oriented in the thickness direction D3 is hardly deformed when press molding is performed. Thus, the silencer 1 having high compressive strength in the thickness direction D3 can be obtained. In this respect, although the fibers 34 of the fiber assembly are preferably oriented randomly, the direction of the fibers 34 of the fiber assembly can be oriented in any direction as long as the direction is different from the direction of the fibers 44 of the buffer material 40. For example, the fibers 34 of the fiber assembly can be oriented along the outer surfaces 30a, 30b of the front and back sides. When the fiber assembly in which the fibers are oriented randomly is press molded, the fibers are slightly oriented along the outer surfaces 40a, 40b although the direction is still within the range of randomly oriented direction.

For the fibers 34, reclaimed wool fibers, fibers of the synthetic resin (inclusive of elastomers), fibers obtained by adding an additive to a synthetic resin, inorganic fibers and combination of the above described fibers can be used for example, and fibers including a thermoplastic fiber are preferred. As shown in FIG. 2, the fibers 34 can include the main fiber 35 and the adhesive fiber (binder) 36.

The weight per unit area of the fiber assembly 30 is preferably about 600 to 3000 g/m², and more preferably about 800 to 2000 g/m². The weight per unit area can be changed according to the portions of the silencer 1. The weight per unit area of the fiber assembly 30 is preferably larger than the weight per unit area of the low-density buffer material 40.

At the portion other than the lamination portion 10, the thickness of the fiber assembly 30 is arbitrarily specified according to the vehicle shape within the range of about 10 to 100 mm for example, more preferably within the range of about 15 to 70 mm, further more preferably within the range of about 20 to 50 mm. The density of the fiber assembly 30 is preferably equal to or larger than the density of the buffer material 40, more preferably larger than the density of the buffer material 40. At the portion other than the lamination portion 10, the density of the fiber assembly 30 is preferably about 0.02 to 0.15 g/cm³, more preferably about 0.03 to 0.10 g/cm³. The density of the lamination portion 10 of the fiber assembly 30 is preferably about 0.03 to 0.20 g/cm³, more preferably about 0.04 to 0.15 g/cm³. In particular, the density of the lamination portion 10 of the fiber assembly 30 is preferably equal to or larger than the density of the buffer material 40 (more preferably larger than the density of the buffer material 40) because vibration control performance is improved by suppressing the vibration from the vehicle body panel 80. The fiber assembly 30 having higher density than the buffer material 40 functions as a preferable sound absorbing material because sound absorbing performance and soundproof performance are higher than the buffer material 40 which uses the same kind of fiber. However, since the fibers 34 are not oriented in the thickness direction, compressive strength of the fiber assembly 30 is low in the thickness direction even when the density is higher than the buffer material 40 which uses the same kind of fiber.

The buffer material 40 shown in FIG. 3 is a fiber structure having a wavelike shape formed by repeatedly folding back the web M1 in the thickness direction D3. Thus, the buffer material 40 is light weight, bulky, and has soundproof performance. In particular, compressive strength in the thickness direction D3 is high. Since the fibers 44 of the buffer material 40 are oriented in the thickness direction D3, the buffer material 40 is hardly more deformed than the fiber assembly 30 when press molding is performed. Thus, the silencer 1 having high compressive strength in the thickness direction D3 can be obtained. For the fibers 44, same as the fibers 34 of the fiber assembly, reclaimed wool fibers, fibers of the synthetic resin (inclusive of elastomers), fibers obtained by adding an additive to a synthetic resin, inorganic fibers and combination of the above described fibers can be used for example, and fibers including a thermoplastic fiber are preferred. As shown in FIG. 3, the fibers 44 may include the main fiber 45 and the adhesive fiber (binder) 46.

A thickness of the web M1 before folded can be, for example, about 5 to 10 mm, which is about 3 to 30% of a thickness of the buffer material 40. In addition, the number of folds (number of pleats) of the web M1 can be about 1 to 10 per 20 mm, for example. As the number of folds per unit length becomes smaller, the density of the web M1 decreases, and therefore the web M1 can be formed easier. On the other hand, as the number of folds per unit length becomes larger, the density of the web M1 increases, and therefore shape retaining property is improved and load bearing capacity as a raising material is increased. Note that the number of folds of the web is defined by the number of pleats, and therefore the number of the web per unit length is twice as much as the number of folds.

For manufacturing a buffer material in which a continuous web is repeatedly folded into a wavelike shape and laminated, a manufacturing apparatus can be appropriately selected from various buffer material manufacturing apparatuses using a known manufacturing method such as a STRUTO method.

For the buffer material manufacturing apparatus, a textile lap machine described in Japanese Translation of PCT Application Publication No. 2008-538130, and a machine for repeatedly folding a continuous web into a wavelike shape by gears are known, for example.

In the buffer material 40E shown in FIG. 3 and FIG. 4A, the folded-back surfaces of each of pleats M2 are matched with a plane passing through the width direction D2 and the thickness direction D3 of the buffer material 40E, and the main fiber 45 and the adhesive fiber 46 are oriented in the thickness direction D3, except in the folded-back portions 47. A part of the adhesive fibers 46 is melted and bonds the main fibers 45, which are oriented in a wavelike shape, with each other. As a result, the fiber structure having the wavelike shape is formed. An outer surface 40a of the front side and an outer surface 40b of the back side where the folded-back portions 47 are assembled are formed along the lamination direction D1 of pleats M2 (web M1). The lamination direction D1, the width direction D2 and the thickness direction D3 are approximately perpendicular to each other. Here, the width direction D2 of the buffer material 40E corresponds to the width direction of the web M1. In FIG. 3 and other figures, an extruding direction D11 of the buffer material 40E extruded by the buffer material manufacturing apparatus is shown as one direction of the lamination direction D1, and an opposite direction D12 of the extruding direction D11 is shown as the other direction of the lamination direction D1. If the fibers 44 are oriented in the thickness direction D3, it means that an orientation direction of the fibers 44 matches relatively well with a direction perpendicular to the front surface (40a) and the back surface (40b) in a narrow sense. In addition, the folded-back portion 47 can be formed.

For the main fiber 45 of the buffer material 40 and the main fiber 35 of the fiber assembly 30, fibers of thermoplastic resins (inclusive of thermoplastic elastomers), fibers obtained by adding an additive to thermoplastic resins, inorganic fibers and reclaimed wool fibers can be used, for example. In addition, fibers composed of thermoplastic resins such as a polyester (e.g. PET), a polyolefin (e.g. PP) and a polyamide, fibers composed of thermoplastic resins obtained by modifying the aforementioned thermoplastic resins to adjust a melting point thereof, glass fibers, rayon fibers, reclaimed wool fibers of clothing, regenerated cotton fibers, fibers of materials obtained by further adding an additive, and combinations of these fibers can be also used, for example. A fiber diameter of the main fibers can be about 5 to 60 μm, and a fiber length of the main fibers can be about 10 to 100 mm, for example. When the main fibers are thermoplastic fibers, a melting point of the thermoplastic fibers can be high melting point of about 180 to 260° C., for example. If the reclaimed wool fibers (preferably reclaimed wool fibers of clothing) are used for at least a part of the main fibers 45, 35, sound absorbing performance of the buffer material 40 and the fiber assembly 30 is increased. Thus, these fibers are preferable. The main fiber 45 of the buffer material and the main fiber 35 of the fiber assembly can be the same fiber or can be different fibers.

For the adhesive fiber 46 of the buffer material 40 and the adhesive fiber 36 of the fiber assembly 30, thermoplastic fibers and fibers obtained by adding an additive to thermoplastic resins can be used, for example. In addition, fibers composed of thermoplastic resins such as a polyester (e.g. PET), a polyolefin (e.g. PP and PE (polyethylene)) and a polyamide, fibers composed of thermoplastic resins obtained by modifying the aforementioned thermoplastic resins to adjust a melting point thereof, and fibers of materials obtained by further adding an additive can also be used, for example. When the main fibers are thermoplastic fibers, thermoplastic fibers having a melting point lower than the melting point of the main fibers is preferably used for the adhesive fibers. For example, when fibers having compatibility with the main fibers are used for the adhesive fibers, good adhesion between the main fibers and adhesive fibers can be obtained, and the buffer material 40 and the fiber assembly 30 can be provided with sufficient shape retaining property. A melting point of the adhesive fibers can be about 100 to 220° C. (preferably about 120° C. or less), for example. When the fiber of the same material is used both for the adhesive fibers 46, 36, adhesive performance between the fiber assembly 30 and the buffer material 40 is increased. Thus, the same material is preferred.

Fibers of a core-sheath structure can be used for the adhesive fibers 46, 36. The core-sheath structure is comprised of a sheath portion formed of fibers available for the adhesive fibers and a core portion formed of a material having a melting point higher than that of the sheath portion so that the sheath portion surrounds the outer circumference of the core portion. In this case, fibers available for the main fibers 45, 35 can be used for the core portion.

A fiber diameter of the adhesive fibers 46, 36 can be about 10 to 45 μm, and a fiber length of the adhesive fibers 46 can be about 10 to 100 mm, for example. A compounding ratio of the main fibers 45, 35 and adhesive fibers 46, 36 can be about 50 to 90 wt. % for the main fibers and about 10 to 50 wt. % for the adhesive fibers.

Note that the fiber structure 40 can be also formed by using a non-fibrous binder instead of the adhesive fibers.

The weight per unit area of the buffer material 40 is preferably about 300 to 1500 g/m², and more preferably about 500 to 800 g/m². The thickness of the buffer material 40 is arbitrarily specified according to the vehicle shape within the range of about 10 to 50 mm, for example. The density of the buffer material 40 is preferably equal to or lower than the density of the fiber assembly 30, more preferably lower than the density of the fiber assembly 30. Specifically, the density of the buffer material 40 is preferably about 0.01 to 0.15 g/cm³, more preferably 0.02 to 0.08 g/cm³.

When the compressive strength of the buffer material 40 was actually measured, the compressive strength was 1.5 to 40 kPa when the density was 0.01 to 0.15 g/cm³ and 2 to 15 kPa when the density was 0.02 to 0.08 g/cm³. The compressive strength is a value obtained by measuring the compressive stress at a 25% strain using a precision universal testing machine AG-500A manufactured by Shimazu KK. The measurements are conducted under the following test conditions; specimen size: 50 mm×50 mm×thickness of 20 mm, compression rate: 10 mm/min, compression zone: entire surface, and no pre-compression.

The buffer material 40 can be any structure as long as the fibers 44 are oriented in the thickness direction D3. Accordingly, as shown in FIG. 4B, the folded-back portions 47 of the outer surfaces 40a, 40b of the buffer material 40 can be cut out. Further, the buffer material obtained by dividing the fiber structure having a wavelike shape at an intermediate position in the thickness direction can be used.

The thickness direction of the buffer material 40 in the present technology can be any direction as long as the direction is crossing the first and second molding surface 11, 12 shown in FIG. 2. Thus, the thickness direction is not limited to the direction exactly the thickness direction of the silencer 1 having unevenness. The thickness direction can be the direction deviated from the thickness direction of the silencer 1.

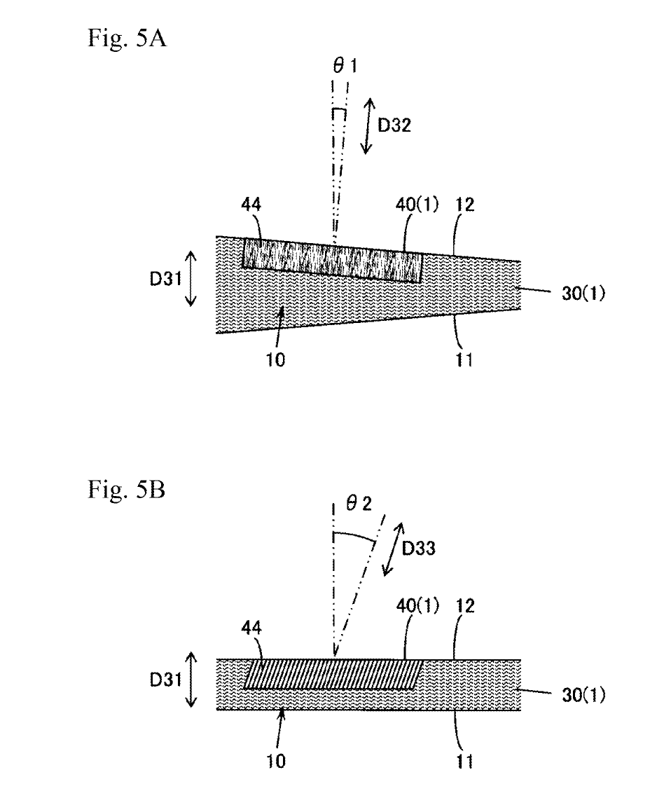

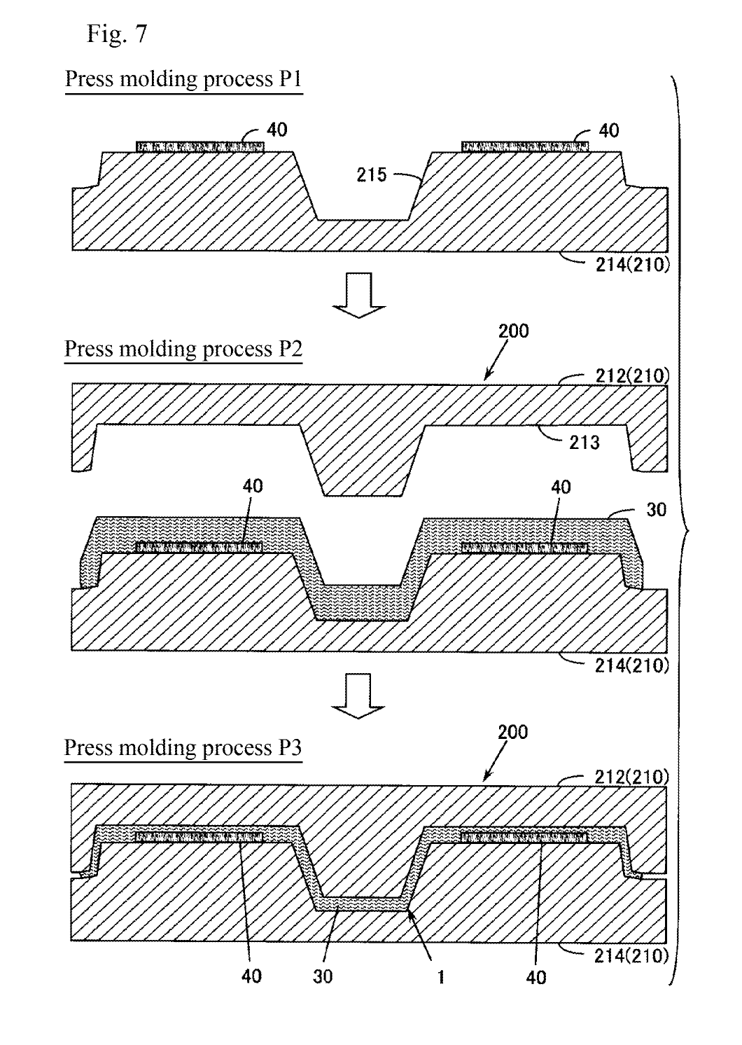

In the example shown in FIG. 5A, the thickness of the silencer 1 is not constant and deviated from a compression direction D31 to a thickness direction D32 of the buffer material 40. The compression direction D31 is an approach direction of molds 212, 214 of a press molding machine 200 shown in FIG. 7. The compression direction D31 is a direction of applying compression force when press molding is performed. The compression direction D31 can be replaced with the thickness direction of whole the silencer 1. An angle θ1 formed by the compression direction D31 and the thickness direction D32 of the buffer material is preferably 30° or less, and more preferably 25° or less, further more preferably 20° or less, and particularly preferably 15° or less in a viewpoint of obtaining good compressive strength in the compression direction D31. Of course, the present invention also includes the case of θ1>0.

As exemplified in FIG. 5B, when the compression force is applied by the press molding, the direction of the fibers 44 of the buffer material 40 may be deviated from the thickness direction of the buffer material 40 and deviated from the compression direction D31. An angle θ2 formed by the compression direction D31 and a direction D33 of the fibers 44 is preferably 30° or less, more preferably 25° or less, further more preferably 20° or less, and particularly preferably 15° or less in a viewpoint of obtaining good compressive strength in the compression direction D31. Of course, the present invention also includes the case of θ2>0.

(3) Manufacturing Method, Operation and Effect of the Silencer

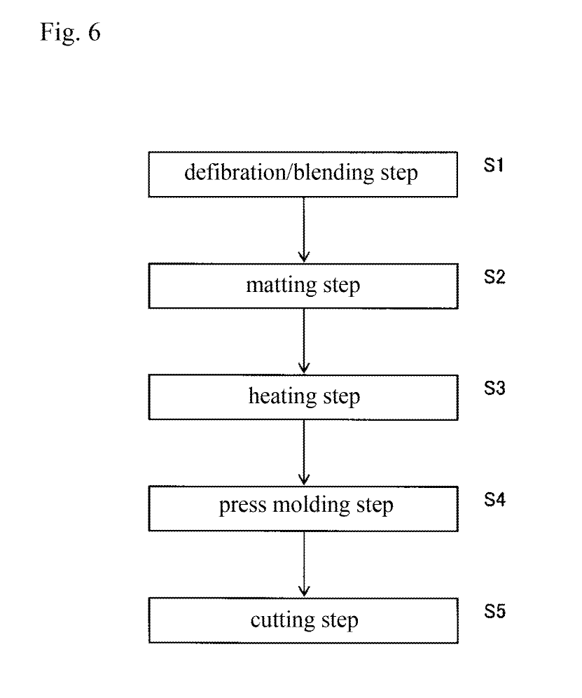

FIG. 6 schematically shows an example of a manufacturing method of the silencer 1 for automobile. FIG. 7 schematically shows an example of a vertical end surface of the press molding machine 200. In the manufacturing method, the fiber assembly 30 is formed from raw yarn such as a combination of reclaimed wool fiber, synthetic resin fiber and adhesive fiber. Then, the buffer material 40 is inserted into the fiber assembly 30 and press molding is preformed.

When the manufacturing process is started, the raw yarn is defibrated and blended (defibration/blending step S1), and then the processed raw yarn is measured so that the weight per unit area becomes a predetermined weight (matting step S2). The matted raw yarn is conveyed to a heater such as a suction heater (hot air circulation heater), and pre-heated at a temperature a little higher than a melting point of the adhesive fibers 36 by a hot air heating or the like to soften the adhesive fibers 36 (heating step S3). A radiation heating by the infrared radiation heater can be done simultaneously with the heating of the suction heater so as to ensure the sufficient amount of heat. Of course, the heating can be done without using the suction heater.

In the heating step S3, a preform can be formed by preliminary molding the matted raw yarn in accordance with the shape of the silencer 1. If the preform is formed, the adhesiveness between the side portion 31a of the concave portion 31 of the fiber assembly 30 and the circumferential portion 40c of the buffer material 40 is increased.

After the heating is finished, the matted raw yarn or the preform is conveyed to the press molding machine 200 and press molded (press molding step S4). Here, as shown in the press molding process P1 shown in FIG. 7, the buffer material 40 is preliminarily placed on a predetermined portion of a lower mold 214. The direction of the buffer material 40 can be set so that the lamination direction D1 matches with the vehicle width direction or the width direction D2 matches with the vehicle width direction. Otherwise, the lamination direction D1 and the width direction D2 can be deviated from the vehicle width direction. As shown in the press molding process P2 shown in FIG. 7, the matted raw yarn or the perform (fiber assembly 30 before press molding) conveyed to the press molding machine 200 is laid on the lower mold 214 which is placed on the buffer material 40.

In the press molding machine 200 shown in FIG. 7, an upper mold 212 and a lower mold 214 both constituting a forming die 210 are provided so that they can be brought close to each other and separate from each other. The upper mold 212 is a metal mold having a molding surface 213 on a facing surface so as to match with a shape of the vehicle body panel 80 side of the silencer 1. The lower mold 214 is a metal mold having a molding surface 215 on a facing surface so as to match with a shape of the carpet 20 side of the silencer 1. Accordingly, before performing the press molding, the fiber assembly 30 and the buffer material 40 are arranged with their upper and lower sides reversed between the molds 212, 214. Of course, before performing the press molding, the materials can be arranged in accordance with the positional relation to be laid on the automobile. The press molding can be cold press without using heat or hot press using heat. When the hot press is performed, the adhesiveness between the side portion 31a of the concave portion 31 of the fiber assembly 30 and the circumferential portion 40c of the buffer material 40 is increased.

When the matted law yarn or the perform (30) is laid on the buffer material 40 placed on the lower mold 214 (press molding process P2) and the molds 212, 214 are brought close to each other, the silencer 1 before trimming is press molded (press molding process P3). Here, the fibers 44 of the buffer material 40 are oriented in the thickness direction D3. Thus, the buffer material 40 has high compressive strength in the thickness direction D3. Further, the buffer material 40 is hardly deformed in the thickness direction D3 even when the press molding is performed. Hence, the material mainly compressed is the fiber assembly 30. When the matted law yarn is used, the concave portion 31 is formed by making the buffer material 40 sink into the law yarn by the press molding. Accordingly, the manufacturing method of using the matted law yarn is preferable because the concave portion 31 is formed when finally forming the silencer by the press molding. Even when using the preform, the lamination portion 10 of the fiber assembly 30 may be compressed by the press molding.

From the above, the lamination portion 10 of the fiber assembly 30 is more strongly compressed than the surrounding area. Thus, the density of the lamination portion 10 becomes high. Accordingly, vibration control performance, soundproof performance and sound insulation performance are increased. In particular, since the fiber assembly 30 is located at the vehicle body panel 80 side in the lamination portion 10, vibration control performance, soundproof performance and sound insulation performance are increased.

From the above, the silencer 1 of the present technology can have high compressive strength while having low density in the lamination portion 10 compared to the silencer formed only by the fiber assembly in which the fibers are not oriented in the thickness direction. The lamination portion 10 is located at the floor panel (80) side of the footrest portion 23 of the carpet 20. Thus, the silencer 1 of the present technology is tough against the “settling”, which is a situation that the fiber assembly is compressed in a thickness direction and not returned to an original thickness. Accordingly, the present technology can give comfortable feeling of stepping to the passenger for a long time. In particular, since the buffer material 40 is located at the carpet 20 side on the lamination portion 10, the feeling of stepping is improved. In the silencer 1 of the present technology, the fiber assembly 30 is provided on the lamination portion 10. Thus, vibration control performance, soundproof performance and sound insulation performance can be improved compared to the silencer formed only by the buffer material in which fibers are oriented in the thickness direction.

When the binder such as the adhesive fiber 36 is included in the fiber assembly 30, the shape of the fiber assembly 30 is maintained by the binder, and the buffer material 40 adheres to not only the bottom portion 31b of the concave portion 31 of the fiber assembly 30 but also the side portion 31a of the concave portion 31. When the binder such as the adhesive fiber 46 is included in the buffer material 40, the shape of the buffer material 40 is maintained by the binder, and the buffer material 40 adheres to not only to the bottom portion 31b of the concave portion 31 of the fiber assembly 30 but also the side portion 31a of the concave portion 31. Since both the fiber assembly 30 and the buffer material 40 are fibrous, good adhesiveness can be obtained between the fiber assembly 30 and the buffer material 40. If the fiber assembly 30 is not the preform and not heated, even when the buffer material 40 in which the fibers are oriented in the thickness direction is heated for retaining fiber structure and the adhesive fiber (binder) is hardened, the adhesiveness between the fiber assembly 30 and the buffer material 40 is increased by the not-heated adhesive fiber (binder) included in the fiber assembly 30.

The silencer 1 before trimming is cooled and removed from the press molding machine 200, and then conveyed to an outer circumference cutting machine to cut the outer circumference (cutting step S5). The cutting method can be a cutting using a cutting blade, a water jet cutting or cutting by hand using a cutter for example.

In the obtained silencer 1, the buffer material 40 in which the fibers are oriented in the thickness direction is located at the floor panel (80) side of the footrest portion 23 of the carpet 20. Accordingly, compressive strength in the thickness direction is high and performance when stepped on by the foot is good. If the buffer material 40 is not provided, the above described “settling” easily occurs when the force is continuously applied in the thickness direction by the stepping of the passenger and the like. Accordingly, in the conventional silencer, the density should be high to keep a certain feeling of stepping. Thus, the weight of the product is increased. In the silencer 1 of the present technology, the fibers of the buffer material are oriented in the thickness direction. Thus, repulsion force in the thickness direction is high and the certain feeling of stepping and settling resistance can be kept even when the density is lower than the conventional silencer. Hence, the present technology can provide a new silencer for automobile partly having high compressive strength in the thickness direction. The density of the silencer can be reduced to reduce the weight of the silencer. Thus, a light-weight silencer for automobile having comfortable feeling can be provided. There is excellent effect such as cost reduction. Both the fiber assembly 30 and the buffer material 40 are fibrous. Thus, the silencer 1 is light weight. Further, the adhesiveness between the fiber assembly 30 and the buffer material 40 is increased by entangling the fibers 34, 44 with each other.

In addition, the buffer material 40 in which the fibers are oriented in the thickness direction is located at the skin material (20) side of the silencer 1. Thus, the feeling of the buffer material 40 can be easily obtained.

Furthermore, in the lamination portion 10, the density of the fiber assembly 30 located at the vehicle body panel 80 side of the silencer 1 is higher than the density of the buffer material 40. Thus, good vibration control performance can be obtained.

(4) Variation Examples

Following variation examples can be considered in the present invention.

For example, in addition to the floor silencer for the vehicle compartment, the silencer for automobile of the present invention can be applied to a silencer for a luggage compartment, a silencer for a door part, a silencer for a ceiling part, a dash silencer, a silencer for an engine part and a silencer for a fender part.

Another layer such as an adhesive layer can be formed between the fiber assembly 30 and the buffer material 40, for example.

FIG. 8 shows a vertical end surface of a silencer 1A of the variation example together with the vehicle body panel 80 and the carpet 20 cut at the position corresponding to A1-A1 in FIG. 1. Note that the concept of the silencer 1 described above includes the silencer 1A.

On the outer surface 30b of the back side (vehicle body panel 80 side) of the fiber assembly 30 shown in FIG. 8, a concave portion 31 recessed toward the carpet 20 side is formed. The buffer material 40 is inserted into the concave portion 31. The bottom portion 31b of the concave portion 31 is adhered to on the outer surface 40a located at the front side (carpet 20 side) of the buffer material 40. The side portion 31a of the concave portion 31 is adhered to on the circumferential portion 40c of the buffer material 40. The outer surface 30b of the back side of the fiber assembly 30 located around the concave portion 31 and the outer surface 40b of the back side of the buffer material 40 are the first molding surface 11. On the outer surface 30a of the front side of the fiber assembly 30, the concave portion into which the buffer material is inserted is not formed. Accordingly, the outer surface 30a of the front side is the second molding surface 12, and the outer surface of the buffer material 40 is not included in the second molding surface 12.

The buffer material 40 shown in FIG. 8 is formed in a three-dimensional shape having a size of substantially filling the concave portion 31 of the fiber assembly. Hence, the buffer material 40 inserted into the concave portion 31 is not protruded (convex shape) from the outer surface 30b of the back side located around the buffer material 40. Thus, the outer surface 40b of the back side of the buffer material 40 and the outer surface 30b of the back side of the fiber assembly 30 become approximately flat. Accordingly, the load applied from the carpet 20 side to the vehicle body panel 80 side is suitably supported by the buffer material 40 via the fiber assembly 30. When the difference in level between the outer surface 40b of the back side of the buffer material and the outer surface 30b of the back side of the fiber assembly is 0.3 times or less of the thickness of the buffer material 40 (more preferably 0.2 times or less, furthermore more preferably 0.1 times or less), the outer surface 40b of the back side of the buffer material and the outer surface 30b of the back side of the fiber assembly are approximately flat.

Since the buffer material 40 in which the fibers are oriented in the thickness direction is located at the vehicle body panel 80 side, the load applied from the carpet 20 side to the vehicle body panel 80 side is supported by the fibers 44 oriented in the thickness direction D3 of the buffer material 40 via the fiber assembly 30. Accordingly, the variation example can provide the silencer for automobile having higher compressive strength in the thickness direction.

When the skin material (e.g. carpet 20) does not have an air-impermeable layer and has air permeability in the thickness direction, the buffer material 40 is preferably arranged on the vehicle body panel 80 side as shown in FIG. 8. In this case, sound wave directed from the vehicle compartment C1 side to the silencer 1A passes through the skin material and enters in the silencer 1A. Thus, sound absorbing function is achieved. Namely, in this case, the silencer can control a flow resistance value of the vehicle compartment C1 side by the fiber assembly 30. Thus, soundproof performance is increased.

On the other hand, when the skin material (e.g. carpet 20) has the air-impermeable layer and permeation in the thickness direction is blocked, the buffer material 40 is preferably arranged on the skin material side as shown in FIG. 2. In this case, sound wave directed from the vehicle body panel 80 side toward the silencer 1A is reflected at the air-impermeable layer of the skin material. Thus, sound absorbing function is achieved. Namely, in this case, the silencer can suppress the vibration transmitted from the vehicle body panel 80 by the high-density fiber assembly 30 arranged on the lamination portion 10. Thus, vibration control performance is increased.

As shown in the variation example of FIG. 9A, the concept of the above described silencer 1 includes a silencer 1B. In the silencer 1B, the buffer material 40 is embedded in the fiber assembly 30.

As shown in the variation example of FIG. 9B, the concept of the above described silencer 1 includes a silencer 1C. The silencer 1C includes buffer material 40 having an approximately trapezoidal cross section. The buffer material 40 of the silencer 1C is formed in an approximately trapezoidal cross section when cut along the thickness direction D3 so that the length L1 of a side at the first molding surface 11 side and the length L2 of a side at the second molding surface 12 side are different. From the above, in the buffer material 40, an area of the outer surface 40a of the front side is different from an area of the outer surface 40b of the back side. When the buffer material 40 is formed in an approximately trapezoidal cross section, adhesive strength between the buffer material 40 and the fiber assembly 30 becomes higher at the circumferential portion 40c compared to the buffer material 40 having a rectangular cross section. As shown in the buffer material 40 of FIG. 9B, the length L2 of the side of the outer surface 40a included in the molding surface 12 is longer than the length L1 of the outer surface 40b side not included in the molding surfaces 11, 12, the width of the concave portion 31 of the fiber assembly 30 becomes wider as the position becomes shallower. Thus, the concave portion 31 can be easily formed. Accordingly, adhesive strength between the circumferential portion 40c of the buffer material and the side portion 31a of the concave portion becomes higher. When the length L2 of the side of the outer surface 40a included in the molding surface 12 is shorter than the length L1 of the side of the outer surface 40b not included in the molding surfaces 11, 12, the concave portion 31 of the fiber assembly 30 becomes narrower as the position becomes shallower. Thus, adhesive strength between the circumferential portion 40c of the buffer material and the side portion 31a of the concave portion becomes higher.

From the above, the variation example can increase the adhesive strength of the buffer material adhered to on the fiber assembly.

Note that same effect can be obtained when the buffer material 40 of the silencer 1A shown in FIG. 8 is formed in an approximately trapezoidal cross section, and when the buffer material 40 of the silencer 1B shown in FIG. 9A is formed in an approximately trapezoidal cross section. In addition, the above described buffer material formed in an approximately trapezoidal cross section also includes the case that the buffer material having an approximately rectangular cross section is inserted and deformed in an approximately trapezoidal cross section when press molding is performed.

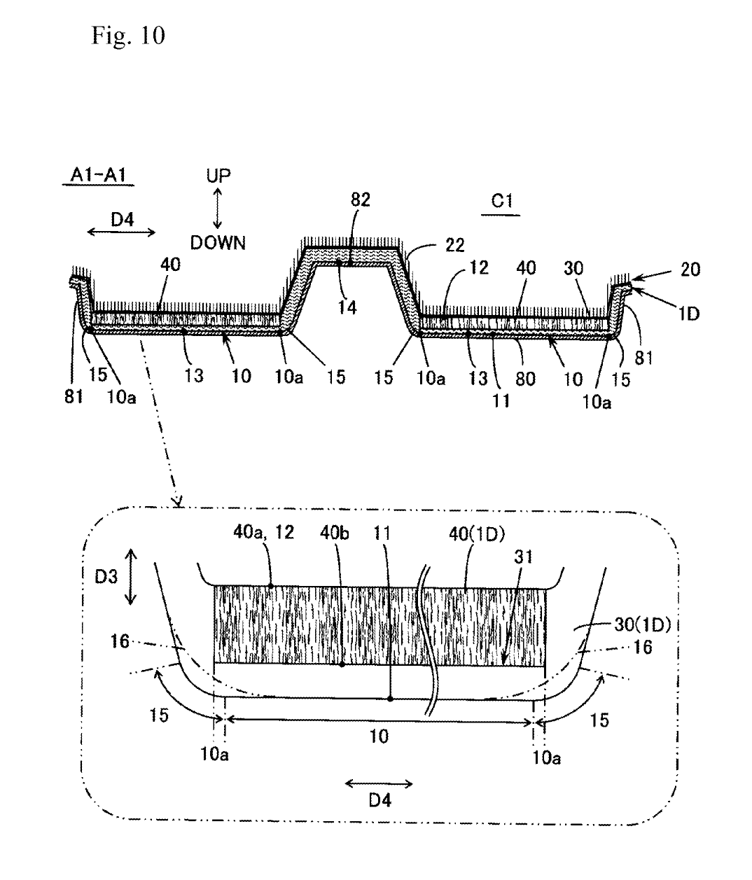

FIG. 10 shows a vertical end surface of a silencer 1D included in the concept of the above described silencer 1 together with the vehicle body panel 80 and the carpet 20 cut at the position corresponding to A1-A1 in FIG. 1. In a lower part of FIG. 10, a main portion of the silencer 1D is schematically shown.

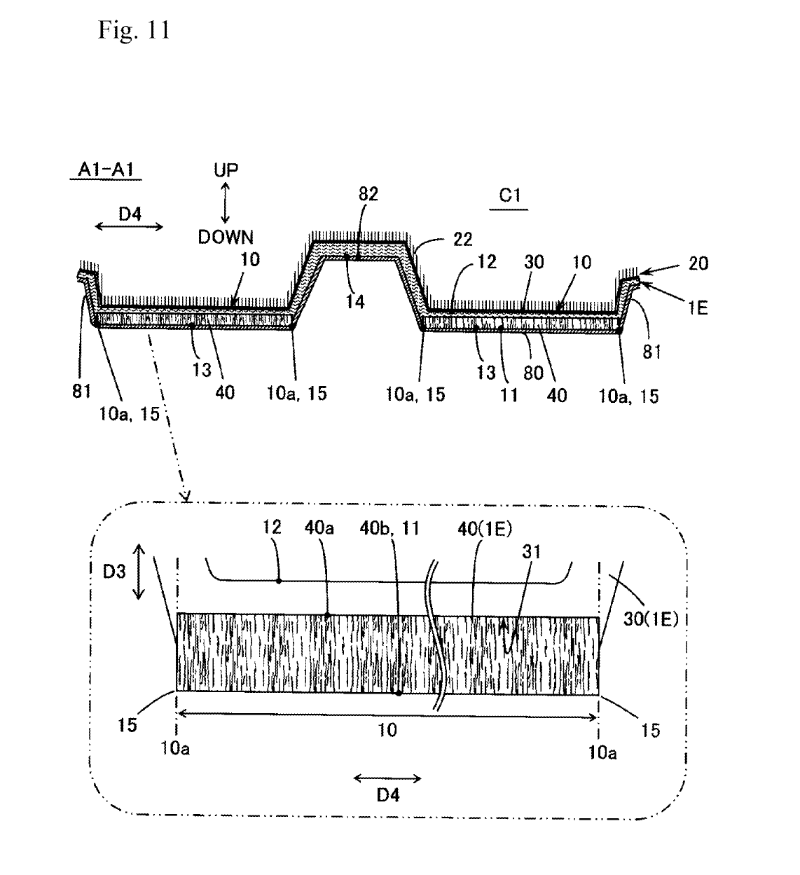

On the first molding surface 11 shown in FIG. 10, a roundly protruded convex portion 15 is formed on the buffer material 40 at a position of an edge portion 10a of the lamination portion 10 in a direction D4 (lateral direction in FIG. 10) different from the thickness direction D3 of the buffer material 40. The direction D4 can be the longitudinal direction or the direction deviated from the longitudinal direction. The direction D4 can be the lamination direction D1 of the web M1, the width direction D2 of the web M1, or the direction different from both directions D1, D2. As shown in a lower part of FIG. 10, the edge portion 10a of the lamination portion 10 is the projected position of the edge portion (circumferential portion 40c) of the buffer material 40 when the buffer material 40 is projected in the thickness direction D3. When the position of the circumferential portion 40c in the direction D4 is different between the edge portion of the first molding surface 11 side and the edge portion of the second molding surface 12 side, such as when the buffer material 40 is formed in an approximately trapezoidal cross section, the edge portion 10a of the lamination portion is the projected position of the edge portion of one of the molding surfaces 11, 12 on which the convex portion 15 is formed when the buffer material 40 is projected in the thickness direction D3. For example, when the convex portion 15 is formed on the first molding surface 11 and the buffer material 40 is formed in an approximately trapezoidal cross section as shown in FIG. 9B, the edge portion 10a of the lamination portion is the projected positon of the edge portion of the outer surface 40b of the back side of the buffer material 40 when the buffer material 40 is projected in the thickness direction D3. The phrase “the convex portion 15 is formed at a position of an edge portion 10a of the lamination portion 10” means that the edge portion 10a of the lamination portion 10 is located in a range of the convex portion 15. The range of the convex portion 15 is the range of the outer surface of the silencer protruded outward. For example, the range of the convex portion 15 is the range of the surface having a curvature radius protruding outward of the silencer. The shape of the convex portion 15 is not limited to the roundly protruded shape having a constant curvature radius (referred to as R). In the roundly protruded shape, the curvature radius can be changed according to the position. The same can be said about a silencer 1E (shown in FIG. 11) explained later.

In this variation example, same as the silencer 1 shown in FIG. 2, the concave portion 31 recessed toward the vehicle body panel 80 side is formed on the outer surface of the front side (carpet 20 side) of the fiber assembly 30. The buffer material 40 is inserted into the concave portion 31. The outer surface 40b of the buffer material 40 is not included in the first molding surface 11. The outer surface 40a of the buffer material 40 is included in the second molding surface 12.

In the silencer, when the edge portion of the lamination portion 10 is not located at the portion such as a corner portion where the convex portion 15 needs to be formed, repulsion force of the fiber assembly 30 is relatively low and therefore a broad convex portion 16 having large curvature radius R is formed as shown in a lower part of FIG. 10. In order to reduce the curvature radius R without using the buffer material 40, the density of the fiber assembly 30 should be increased to increase the repulsion force of the fiber assembly 30. In this variation example, since the convex portion 15 is formed at a position of the edge portion 10a of the lamination portion 10 of the buffer material 40 having low density and high repulsion force, the fibers of the fiber assembly 30 are extruded to the convex portion 15 when press molding is performed. Thus, the roundly protruded shape of the convex portion 15 becomes sharp. Accordingly, the space between the vehicle body panel and the silencer can be reduced and vibration control performance can be increased.

In order to arrange the edge portion 10a of the lamination portion 10 on the convex portion, the edge portion (circumferential portion 40c) of the buffer material 40 should be displaced to be aligned with a vertical wall portion such as the edge portion 81 of the vehicle body panel 80 and the tunnel portion 82 or the buffer material 40 should be extended in the lateral direction or the longitudinal direction. In addition, even when the edge portion (circumferential portion 40c) of the buffer material 40 is partly aligned with the vertical wall portion, vibration control performance is increased. The same can be said about a silencer 1E (shown in FIG. 11) explained later.

FIG. 11 shows a vertical end surface of the silencer 1E included in the concept of the above described silencer 1 together with the vehicle body panel 80 and the carpet 20 cut at the position corresponding to A1-A1 in FIG. 1. In a lower part of FIG. 11, a main portion of the silencer 1E is schematically shown.

In the first molding surface 11 shown in FIG. 11, the convex portion 15 is formed by the edge portion of the buffer material 40 at a position of the edge portion 10a of the lamination portion 10 in the direction D4 (lateral direction in FIG. 11) different from the thickness direction D3 of the buffer material 40.

In this variation example, same as the silencer 1A shown in FIG. 8, the concave portion 31 recessed toward the carpet 20 side is formed on the outer surface of the back side (vehicle body panel 80 side) of the fiber assembly 30. The buffer material 40 is inserted into the concave portion 31. The outer surface 40a of the buffer material 40 is not included in the second molding surface 12. The outer surface 40b of the buffer material 40 is included in the first molding surface 11.

In this variation example, the convex portion 15 is formed by the edge portion (circumferential portion 40c) of the buffer material 40 having low density and high repulsion force, the roundly protruded shape of the convex portion 15 becomes sharper than the silencer 1D shown in FIG. 10. Accordingly, the space between the vehicle body panel and the silencer can be further reduced and vibration control performance can be further increased.

The convex portion 15 formed at the position of the edge portion 10a of the lamination portion 10 can be formed on the second molding surface 12. Of course, the convex portion 15 can be formed both on the first molding surface 11 and the second molding surface 12.

As explained above, when the convex portion 15 is formed at the position of the edge portion 10a of the lamination portion 10 on at least one of the molding surfaces 11, 12, the shape of the convex portion 15 such as the corner portion can be sharp. Accordingly, the silencer having the convex portion 15 can reduce the space between the vehicle body panel and the silencer, and increase the vibration control performance.

When the thickness of the lamination portion 10 formed by inserting the buffer material 40 in which the fibers 44 are oriented in the thickness direction D3 into the fiber assembly 30 is relatively thick such as when the thickness is more than 50 mm, performance when stepped on by the foot may be deteriorated. For example, the foot sinks when stepped on the footrest portion 23 (shown in FIG. 1) of the floor carpet 20. In this case, a foamed molded body having a predetermined thickness (e.g. about 10 to 20 mm) can be attached afterward on at least the second molding surface 12 of the lamination portion 10 of the silencer 1 by using hot melt or other method. In this case, the thickness of the lamination portion 10 can be specified so that the thickness is reduced by the thickness of the foamed molded body with respect to the thickness of the silencer 1 at the position corresponding to the footrest portion 23. The material of the foamed molded body is preferably a material formed by foaming resin molding material containing synthetic resin. The synthetic resin is preferably thermoplastic resin such as PP, PE, PS and acrylic-styrene. The foamed molded body is preferably a bead foam-molded body of foamable resin particles. When the formed molded body is attached afterward, the foot sinks less when stepped on the footrest portion 23. Thus, the performance when stepped on by the foot is increased.

(5) Working Example

Hereafter, the present invention will be explained concretely showing a working example. The present invention is not limited to the working example.

[Producing Buffer Material]

For the main fiber, reclaimed wool fibers of clothing were used. For the adhesive fiber, PET/PET core sheath fibers were used. 70 wt. % of the main fiber and 30 wt. % of the adhesive fiber were mixed and aligned by a carding process to form a web having a thickness of 5 mm. The above described web was folded in a pleat shape by a textile lap machine similar to the machine described in Japanese Translation of PCT2008-538130 to form a sample of the buffer material having the weight per unit area of 600 g/m², the thickness of 25 mm, and the number of pleats per unit length of 100/1000 mm.

[Material of Fiber Assembly]

For the main fiber, reclaimed wool fibers of clothing were used. For the adhesive fiber, PET/PET core sheath fibers were used. 70 wt. % of the main fiber and 30 wt. % of the adhesive fiber were mixed to form a material of the randomly oriented fiber assembly.

[Working Example]

The sample of the buffer material and the fiber assembly having the weight per unit area of 900 g/m² were set on a press forming die, and press molded to form a sample of the silencer having the thickness of 45 mm at the lamination portion and the thickness of 30 mm at the portion except for the lamination portion. The weight per unit area of the lamination portion of the sample is 1500 g/m². The buffer material included in the sample was adhered to on the bottom portion of the concave portion of the fiber assembly oriented randomly and the side portion of the concave portion of the fiber assembly oriented randomly. The thickness of the buffer material was 25 mm at the lamination portion. Thus, the thickness was almost same as before the press molding. The density of the fiber assembly was 0.045 g/cm³ at the lamination portion. About the lamination portion, the compressive strength in the thickness direction was measured.

### COMPARATIVE EXAMPLE 1

A material of the fiber assembly having the weight per unit area of 2025 g/m² was set on a press forming die, and press molded to form a sample of the silencer in which the fibers were randomly oriented so that the thickness was 45 mm at a portion corresponding to the lamination portion of the working example and the thickness was 30 mm at a portion except the portion corresponding to the lamination portion of the working example. The density of the fiber assembly was 0.045 g/cm³, which is same as the working example, at the portion corresponding to the lamination portion. About the obtained sample, the compressive strength in the thickness direction was measured.

### COMPARATIVE EXAMPLE 2

A material of the fiber assembly having the weight per unit area of 1500 g/m² was set on a press forming die, and press molded to form a sample of the silencer in which the fibers were randomly oriented so that the thickness of a portion corresponding to the lamination portion of the working example was 45 mm and the thickness of a portion except the portion corresponding to the lamination portion of the working example was 30 mm. The weight per unit area was 1500 g/m², which is same as the working example, at the portion corresponding to the lamination portion. The density of the fiber assembly was 0.033 g/cm³ at the portion corresponding to the lamination portion. About the obtained sample, the compressive strength in the thickness direction was measured.

### Results

The compressive strength of the comparative example 1 at the portion corresponding to the lamination portion was higher than the compressive strength of the comparative example 2 at the portion corresponding to the lamination portion. The compressive strength of the lamination portion of the working example was approximately twice as much as the compressive strength of the comparative example 1 at the portion corresponding to the lamination portion. Accordingly, it was confirmed that the silencer of the present invention partly having high compressive strength in the thickness direction although the weight is lighter than the conventional product.

(6) Conclusion

As explained above, according to various embodiments, the present invention can provide a technology enabling to provide a new silencer for automobile partly having high compressive strength in the thickness direction. Of course, the above-described basic operation and effect can be obtained even with the components described in the independent claims and having no features set forth in the dependent claims.

The present invention can be also implemented by replacing the features disclosed in the above-described embodiments and variation examples with each other or changing the combinations thereof, and the present invention can be also implemented by replacing the conventional features and the features disclosed in the above-described embodiments and variation examples with each other or changing the combinations thereof. The present invention includes these features.

What is claimed is:

1. A silencer for automobile, the silencer being formed by press molding, the silencer having a first molding surface and a second molding surface which are opposite to each other in a thickness direction, the silencer comprising:
a buffer material in which fibers are oriented in the thickness direction; and
a fiber assembly in which fibers are oriented in a different direction from the direction of the fibers of the buffer material, wherein
the buffer material in which fibers are oriented in the thickness direction is inserted into the fiber assembly in which fibers are oriented in the different direction so that a lamination portion is formed by partly laminating the buffer material on the fiber assembly.

2. The silencer for automobile according to claim 1, wherein
a density of the buffer material is equal to or less than the density of the fiber assembly at the lamination portion.

3. The silencer for automobile according to claim 1, wherein
a concave portion is formed on an outer surface of the fiber assembly, and
the buffer material is inserted into the concave portion.

4. The silencer for automobile according to claim 3, wherein
the fibers of the buffer material includes a main fiber and a binder, and
the buffer material is adhered to on a bottom portion of the concave portion of the fiber assembly and a side portion of the concave portion of the fiber assembly.

5. The silencer for automobile according to claim 1, wherein
the first molding surface is located at a vehicle body panel side,
the second molding surface is located at a skin material side, and
the outer surface of the buffer material is included in the second molding surface.

6. The silencer for automobile according to claim 1, wherein
the first molding surface is located at a floor panel side,
the second molding surface is located at a skin material side, and
the lamination portion is located at the floor panel side of the skin material at a portion where a foot of a passenger is placed.

7. The silencer for automobile according to claim 1, wherein
a convex portion is formed on at least one of the first molding surface and the second molding surface, and
the convex portion is located at an edge portion of the lamination portion in a direction different from the thickness direction.
